(19) United States
(12) Patent Application Publication
(10) Pub. No.: US 2014/0288984 A1
(43) Pub. Date: Sep. 25, 2014

(54) SYSTEMS AND METHODS FOR VERIFYING AND REMEDIATING AN ASSIGNED TASK

(71) Applicant: OnlineSkillsCoach, Inc. dba KloudNation, Richardson, TX (US)

(72) Inventor: Reagan V. Jobe, Plano, TX (US)

(21) Appl. No.: 14/219,283

(22) Filed: Mar. 19, 2014

Related U.S. Application Data
(60) Provisional application No. 61/852,696, filed on Mar. 19, 2013.

(51) Int. Cl. G06Q 10/06

(52) U.S. Cl. CPC G06Q 10/063114
USPC 705/7.15

(57) ABSTRACT

Systems and methods for verifying and remediating a task may provide administrators that may distribute or manage a product or a store to become aware in real-time that there are problems with in-store information that may be affecting consumer decisions. Administrators may become aware of problems and manage activities, including making corrections, in real-time without having to be on-site. Administrators may access a centralized system on a user interface through a central portal and create a task to be completed. The system may then allow for the quick release of assigned tasks as well as the ability to run reports for observation in different geographical locations. Users may be prompted to complete a specified task by a specific date/time or at a particular location. Corrective action also may be taken with respect to one or more specified tasks.

### CROSS-REFERENCE TO RELATED APPLICATION

This application claims the benefit of U.S. Provisional Application No. 61/852,696, entitled “SYSTEM AND METHOD FOR VERIFYING AND REMEDIATING AN ASSIGNED TASK,” filed Mar. 19, 2013, which is incorporated herein by reference in its entirety.

### FIELD OF THE DISCLOSURE

The present disclosure generally relates to task management, and more particularly to verifying and remediating assigned tasks.

### BACKGROUND

In the retail environment, approximately 70% of consumer purchase decisions are made in the store and, on average, more than half of all in-store promotional materials are never used. Sometimes decisions are made based on where and how a product is displayed within the store or what other similar or related products may be sold within the store. There are times when the marketing message or the appearance of the store location may negatively affect whether a consumer may purchase a product; however, it is difficult for those that distribute or manage the product or store at an administrator level to know in real-time that there are problems with the message or the appearance that may be affecting consumer purchase decisions.

### SUMMARY

Embodiments of the present disclosure may provide a method for verifying completion of a task using a user interface over a wireless communication network, the method comprising accessing a centralized administration system, creating at least one task associated with a location, the at least one task including at least one question to be answered by at least one user in a remote location, assigning the at least one task to the at least one user, and verifying completion of the at least one task upon receipt of a response from the at least one user. The method may further comprise based on the response from the at least one user, transmitting a correction to the at least one task. The user interface may be selected from the group comprising: a personal computer, a laptop computer, a tablet, a mobile phone, and a mobile communication device. The assigning step may further comprise prompting the at least one user to complete the at least one task by a specific date and time. The response from the at least one user may be selected from the group comprising: providing a yes/no answer, a photo, a video response, an audio response, an answer to a multiple choice question, a textual answer, and combinations thereof. The response may be received from more than one geographical location.

Other embodiments of the present disclosure may comprise a method of task creation for verifying and remediating the task on a centralized administration system via a wireless communication network, the method comprising adding at least one task to the centralized administration system, inputting at least one question associated with the at least one task, transmitting a notification from at least one server to a user interface associated with at least one user to complete the at least one task, reviewing answers to the at least one question associated with the at least one task, and remediating any incorrect answers to the at least one question by transmitting at least one follow up question to the at least one user. The method may further comprise titling the at least one task and entering a description of the at least one task. The method also may comprise selecting at least one limiting element for which the at least one task is associated, the at least one limiting element selected from the group comprising a brand, a product, a service, and a customer. The method may further comprise selecting at least one geographical location to which the at least one task is assigned. The at least one geographical location may comprise one or more of the following: a route, a division, a zone, a city, a state, a country, and a store location. The method may further comprise selecting at least one geographical location to which the at least one task is assigned, and selecting at least one limiting element for which the at least one task is associated, the at least one limiting element selected from the group comprising: a brand, a product, a service, and a customer. The notification may be selected from the group comprising: an email message, a text message, a push notification, and a pop-up notification within a web application. The at least one question may be selected from the group comprising: a yes/no question, a multiple choice question, a barometer-type question, a financial question, a unit/count question, a photo input, a video input, and an audio input.

Further embodiments of the present disclosure may provide a method of a responding to a task created on a centralized administration system over a wireless communication network, the method comprising receiving a notification of at least one task to be completed on a user interface, utilizing the user interface, selecting one of the at least one task and answering questions associated with the task, transmitting to one or more cloud storage databases on the centralized administration system answers to the questions associated with the task, and receiving a notification of corrective tasks to be completed in response to the submitting step. The notification may be selected from the group comprising: an email message, a text message, a push notification, and a pop-up notification within a web application. The user interface may be selected from the group comprising: a personal computer, a laptop computer, a tablet, a mobile phone, and a mobile communication device. The method may further comprise receiving one or more reminders to answer questions associated with the task when the one or more cloud storage databases have not received the answers within a specified period of time. The questions may be selected from the group comprising: a yes/no question, a multiple choice question, a barometer-type question, a financial question, a unit/count question, a photo input, a video input, and an audio input. The user interface may comprise an internal storage database to store answers to the questions when no wireless data connection is available.

### BRIEF DESCRIPTION OF THE DRAWINGS

For a more complete understanding of this disclosure, reference is now made to the following description, taken in conjunction with the accompanying drawings, in which:

FIG. 1 depicts an EasyCheck administration system according to an embodiment of the present disclosure;

FIG. 2 depicts an exploded view of general administration functionality for an EasyCheck administration system according to embodiments of the present disclosure;

FIG. 3 depicts a flow chart related to task creation according to an embodiment of the present disclosure;

FIG. 3a depicts an example of task addition according to an embodiment of the present disclosure;

FIG. 3b depicts an example of titling a task according to an embodiment of the present disclosure;

FIG. 3c depicts an example of a display screen that may be employed to provide a user with an input box to type in a question upon selecting the scale icon according to an embodiment of the present disclosure;

FIG. 3d depicts an embodiment of the present disclosure where several questions are being asked related to a task;

FIG. 3e depicts an example where a price check task may be focused on the South Western region of the country according to an embodiment of the present disclosure;

FIG. 3f depicts selection of certain products and/or certain stores where the task may be performed according to an embodiment of the present disclosure;

FIG. 4 depicts a flow chart for responding to a task according to an embodiment of the present disclosure;

FIG. 5 is a flow chart depicting how results may be reviewed according to an embodiment of the present disclosure;

FIG. 6 is a flow chart depicting how incorrect or undesirable results may be corrected according to an embodiment of the present disclosure; and

FIG. 7 depicts communication between user interfaces and an API server in an administration system according to an embodiment of the present disclosure.

### DETAILED DESCRIPTION

Systems and methods for verifying and remediating a task according to embodiments of the present disclosure may provide administrators that may distribute or manage a product or a store to remotely become aware in real-time that there may be problems with in-store information, including but not limited to, a marketing message, a product display, product arrangement, and/or the store appearance that may be affecting consumer purchase decisions. Administrators may become aware of these problems and manage activities, including making corrections, in real-time without having to be on-site. Systems and methods according to embodiments of the present disclosure may be referred to as EasyCheck.

Systems and methods for verifying and remediating an assigned task may be provided according to embodiments of the present disclosure. An administrator may access the system on a user interface, such as a computer, a tablet, and/or a mobile communication device, through a centralized system or portal over a wireless communication network and create a task or set of tasks to be completed. These tasks may include but are not limited to due dates, instructions, videos, audio recordings and/or documents to provide guidance for proper completion of a task. The centralized system may then allow for the quick release of assigned tasks as well as the ability to run reports for complete observation of tasks being completed in a variety of geographical locations. Methods for communicating tasks according to embodiments of the present disclosure may comprise prompting the user to complete a specified task by a specific date/time and/or at a specified location. Further embodiments of the present disclosure may provide systems and methods to direct corrective action to be taken with respect to one or more specified tasks.

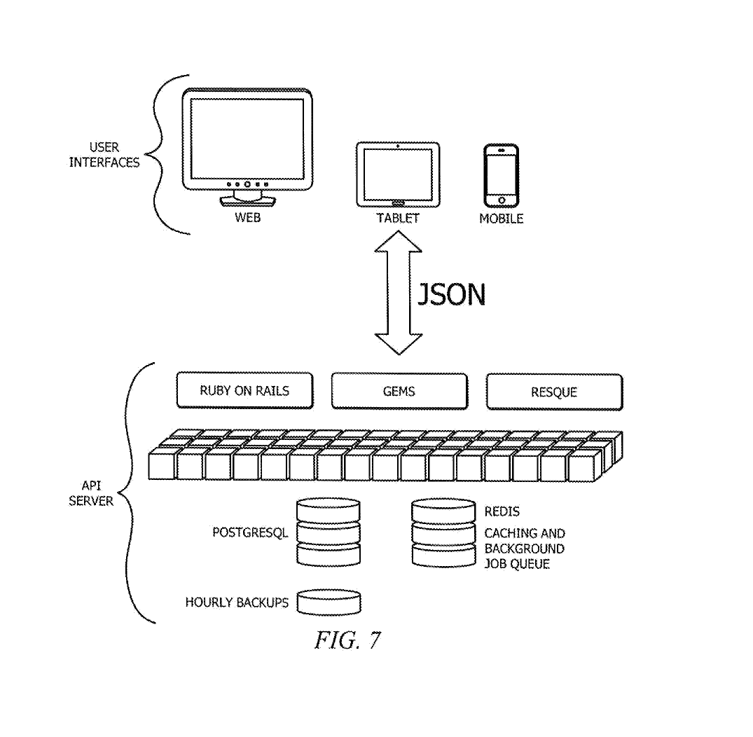

Systems and methods according to embodiments of the present disclosure may provide a highly scalable backend architecture that may allow for ease of use and the ability to adapt quickly to different user interfaces. User interfaces may include mobile as well as fixed devices, including but not limited to, mobile phones, tablets, laptop computers, and desktop computers. Using one or more servers with a dedicated API interface, systems and methods according to embodiments of the present disclosure may pass information between the user interfaces and one or more backend cloud servers using packets of information that may be known to those of ordinary skill in the relevant art, including but not limited to JSON and XML. On the backend, a network of computing devices, such as a Dyno Grid powered by Amazon Web Services, may allow for data to be quickly compiled and processed for use by others in real-time. Additionally, having a network of computing devices may provide for extra redundancy and backup capabilities within systems according to embodiments of the present disclosure. FIG. 7 depicts communication between user interfaces and an API server in an administration system according to an embodiment of the present disclosure.

Systems and methods according to embodiments of the present disclosure may be provided via several stages, including but not limited to, setup, administration, task creation, task assignment, review of results and correction, and analysis of results for future use. Each of these stages are discussed in further detail below.

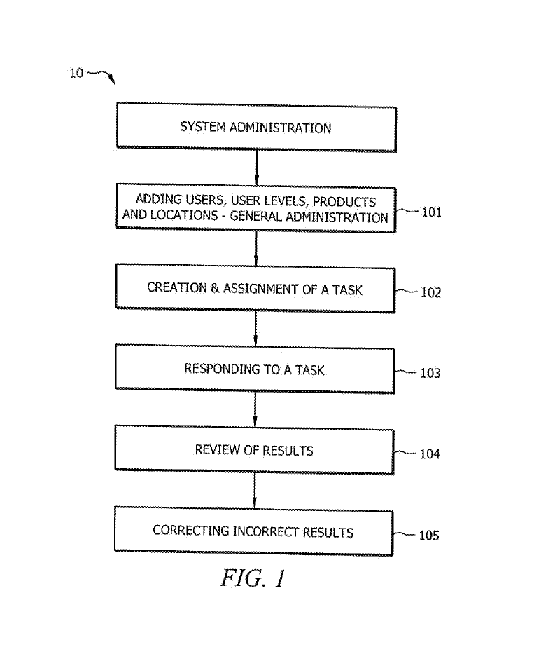

EasyCheck administration system 10 may be provided according to embodiments of the present disclosure as depicted in FIG. 1, wherein various general administration functionalities may be performed including but not limited to addition of clients, removal of clients, pausing use of the system, and other general support. In setting up system 10, locations, routes and management levels may be added and general setup operations may provide the ability for a working environment for system 10 to be established. Clients may be permitted to administer their side of administration system 10 as depicted in block 101 including the addition of users and giving them clearance to perform certain tasks, add products to which a task may be assigned, and also add locations to which a task may be tied. In block 102, tasks may be created and assigned. Accordingly, clients may create, change and provide general administration of a task according to embodiments of the present disclosure. Users may respond to assigned tasks by providing input from the field, including but not limited to, providing photos, video, audio, and answers to questions, in block 103. It should be appreciated that answers to questions may be provided in a variety of different forms according to embodiments of the present disclosure. For example, answers may be provided in a yes/no format, multiple choice, and/or as a textual input without departing from the present disclosure. Block 103 may be referred to as responding to a task. In block 104, users may respond to assigned tasks providing input from the field, including but not limited to, providing photos, video, audio, and/or answers to questions. In block 105, administrators or other specified users may have the ability to view a dashboard of results as input is provided from the field in real-time so that incorrect results may be promptly corrected as described in more detail later. In additional or other embodiments of the present disclosure, administration system 10 may provide for users to be reassigned to different routes or geographical areas. Results may be restricted or filtered with respect to a particular area or product type as described in more detail below. Also, as will be described in more detail below, system 10 may provide the ability to restrict if a user can create tasks or just review tasks within system 10.

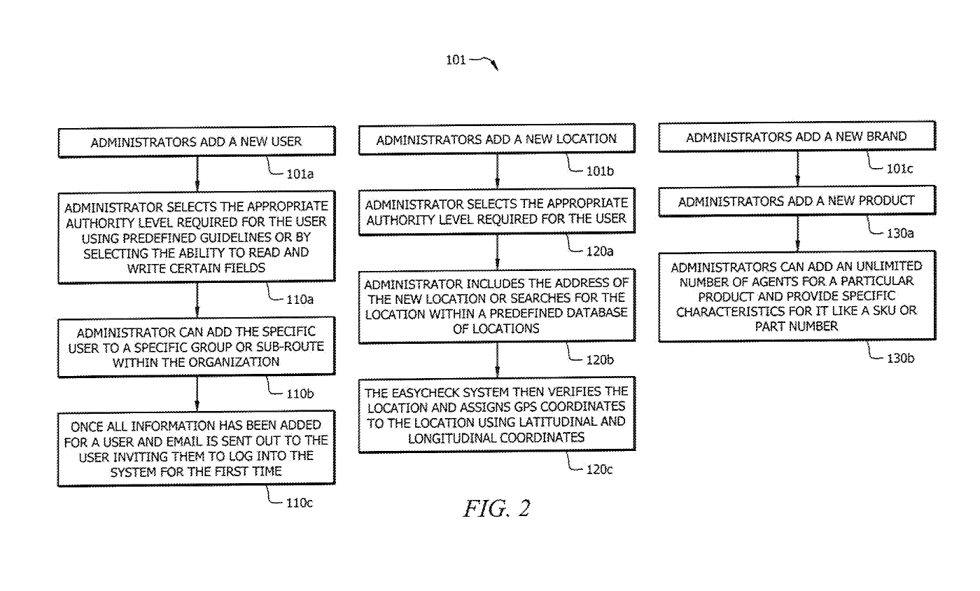

FIG. 2 depicts an exploded view of block 101 that may provide general administration functionality for administration system 10 according to embodiments of the present disclosure. Block 101a depicts a flow chart of certain steps that may be taken for administrators to add a new user according to an embodiment of the present disclosure. In step 110a, an administrator may select the appropriate authority level required for a user using predefined guidelines or by selecting the ability to read and write certain fields. In step 110b, an administrator may add a specific user to a specific group or a sub-route within the organization. In step 110c, once all of the information has been added for a user, an email, text message, or other wireless communication may be transmitted to a user interface associated with the user inviting him/her to access or log into the system. While these steps have been described, it should be appreciated that more or fewer steps may be taken to add a new user without departing from the present disclosure.

Block 101b depicts a flow chart of how administrators may add a new location according to an embodiment of the present disclosure. In step 120a, an administrator may select the appropriate authority level required for a user. In step 120b, an administrator may provide the address of a new location or may search for a location within a predefined database of locations. In step 120c, system 10 may verify the location and then assign GPS coordinates to the location using latitudinal and longitudinal coordinates. Again while these steps have been described, it should be appreciated that more or fewer steps may be taken to add a new user without departing from the present disclosure.

Block 101c depicts a flow chart of how administrators may add a new brand according to an embodiment of the present disclosure. In step 130a, an administrator may add one or more new products. In step 130b, an administrator may add an unlimited number of agents for a particular product and also may provide specific characteristics, such as a SKU or a part number.

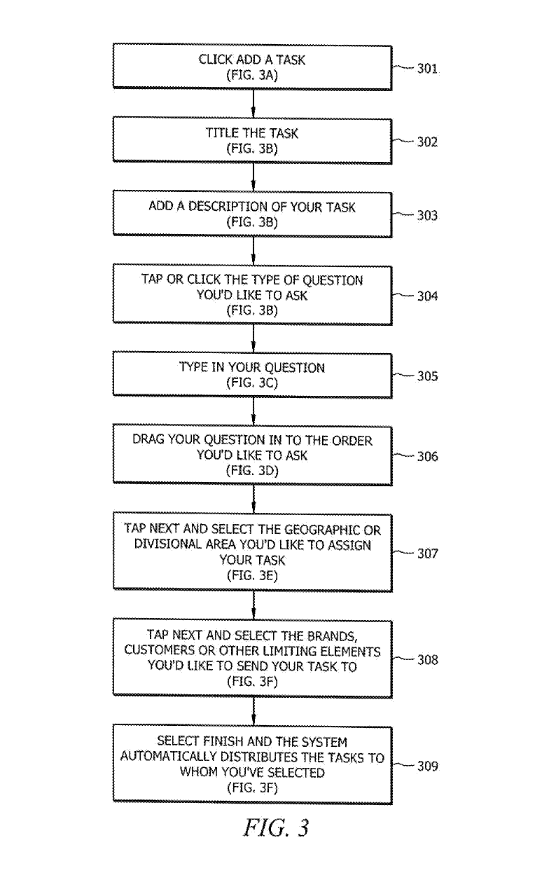

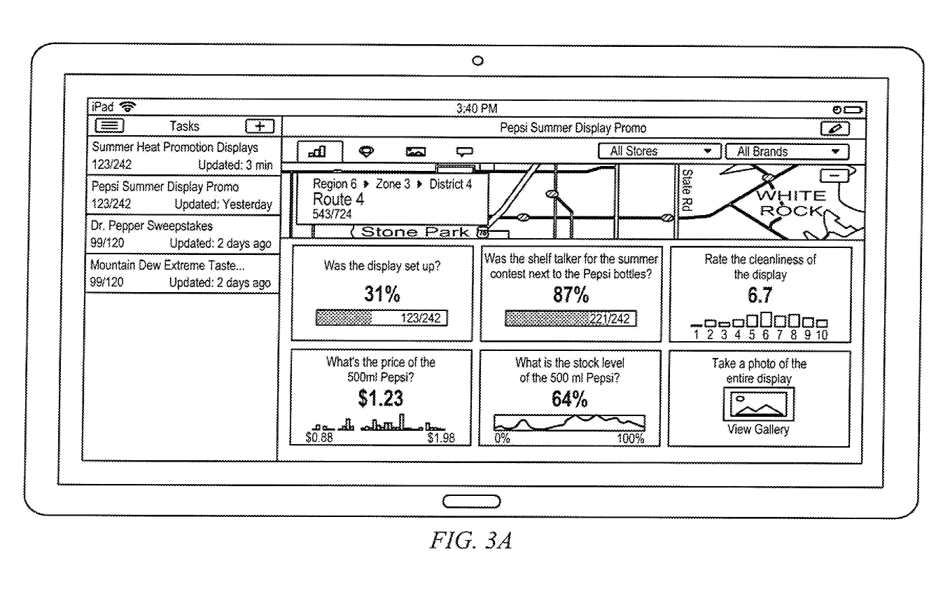

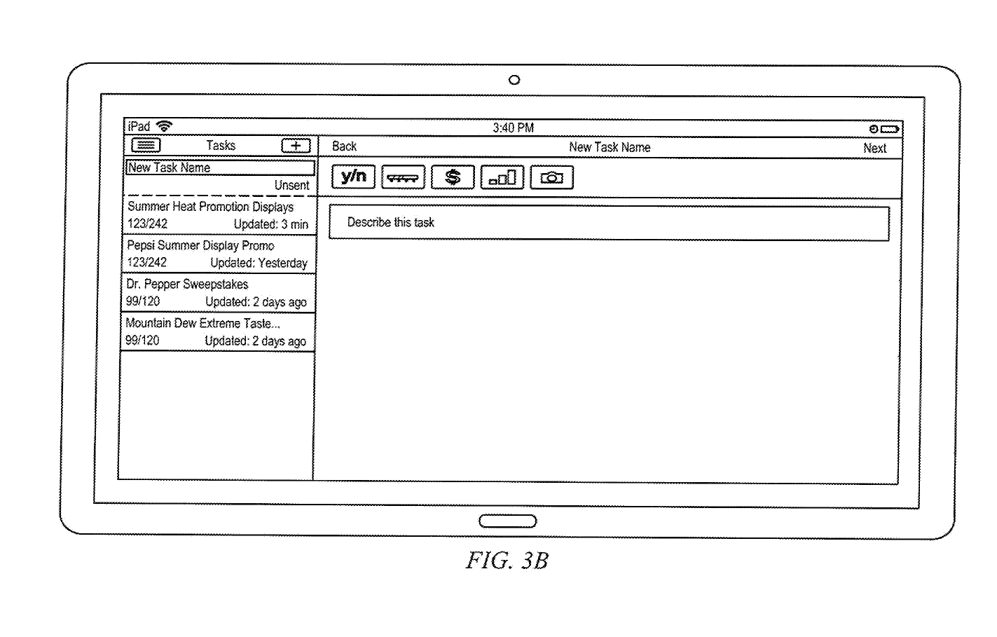

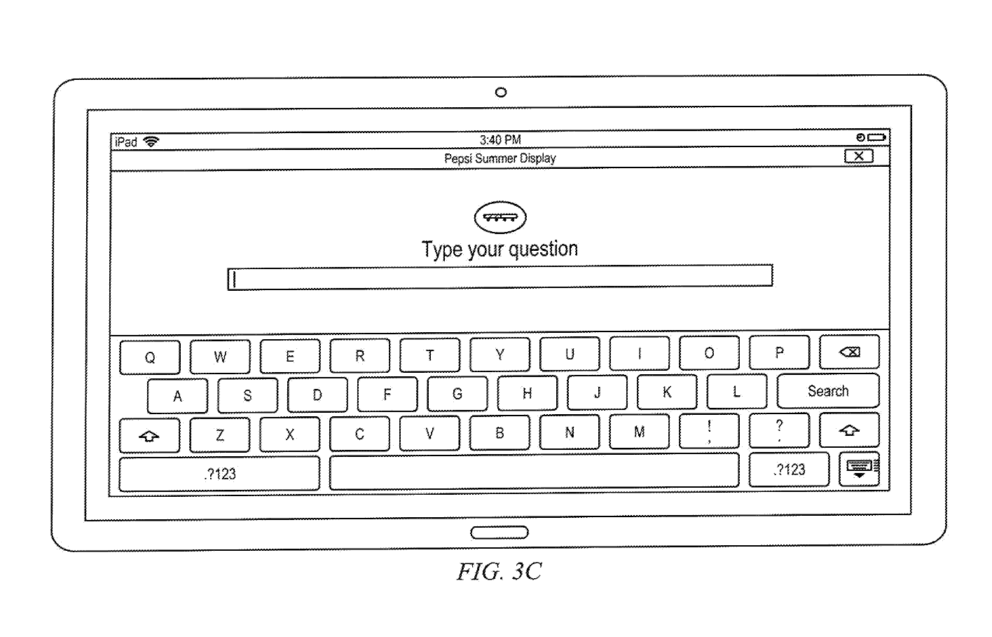

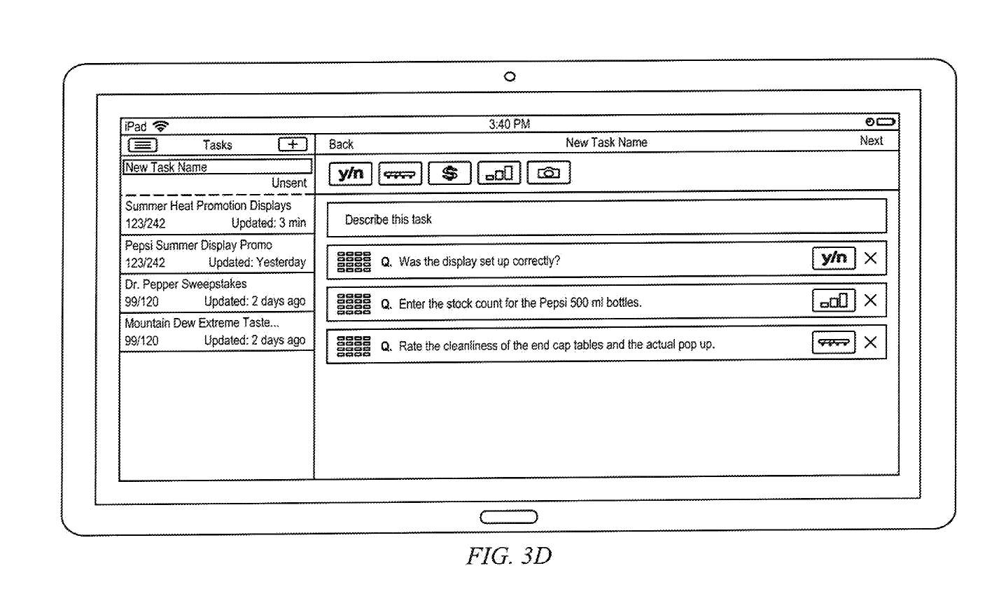

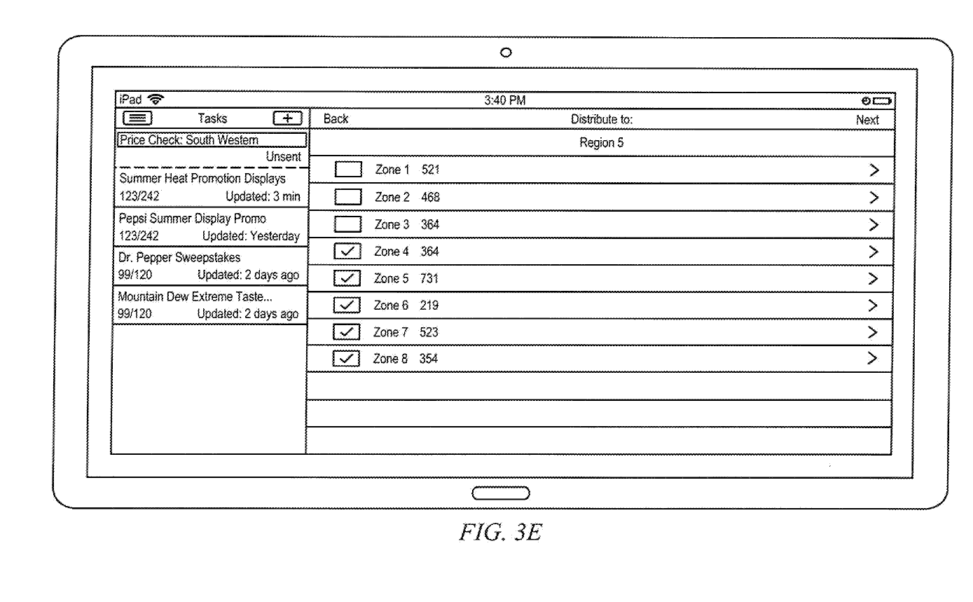

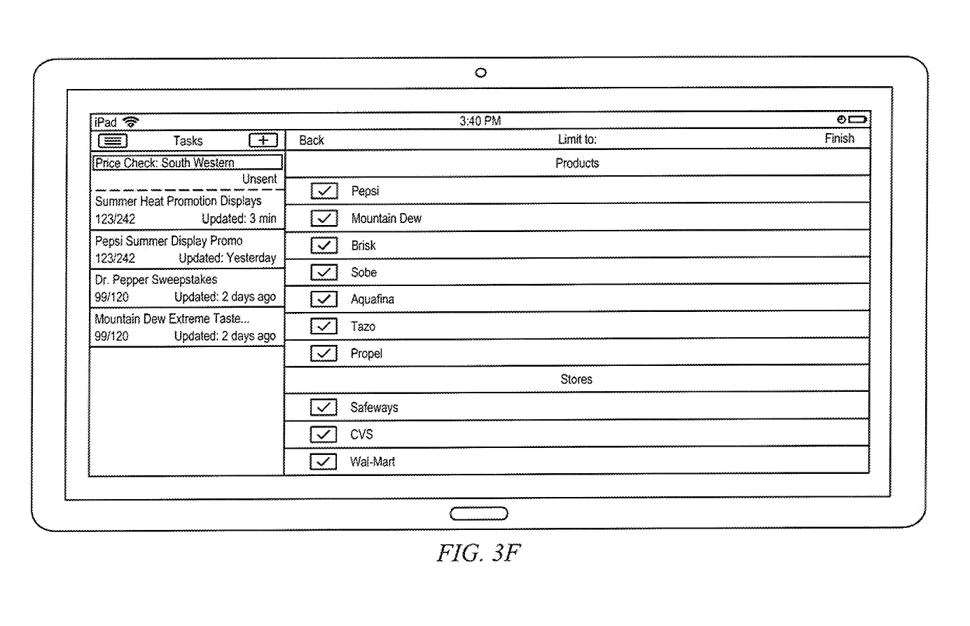

FIG. 3 depicts a flow chart related to task creation according to an embodiment of the present disclosure. It should be appreciated that more or fewer steps for creating a task may be employed without departing from the present disclosure. It also should be appreciated that task creation may be performed through a web-based application or other similar mechanisms that may be utilized on a mobile communication device, such as a tablet or a mobile phone. This may provide administrators with the ability to add tasks while out of the office. In some embodiments of the present disclosure, additional instructions may be associated with a task that is created. Also, when a task is assigned, an administrator may be provided with the ability to associate the task with a particular area (i.e., zone, route, district) as well as the ability to filter to whom the task is sent, such as by product or by retailer/customer as described in more detail below.

In step 301, a task may be added by selecting or clicking an input button (such as “add a task”). FIG. 3a depicts an example of task addition according to an embodiment of the present disclosure. The upper left-hand corner of a display screen may provide an input button for a new task to be added (depicted as a plus sign in FIG. 3a). Tasks that have already been added to the dashboard also may be depicted on the display screen. In this embodiment of the present disclosure, tasks include summer heat promotion displays, Pepsi summer display promo, Dr. Pepper sweepstakes, and Mountain Dew Extreme Taste. It should be appreciated that a plurality of tasks may be displayed on the display screen without departing from the present disclosure. In some embodiments of the present disclosure, the administrator may limit the number of tasks that may be added over a specified amount of time. In other embodiments of the present disclosure, an administrator may be permitted to organize by various parameters including but not limited to date associated with the task, when the task was last updated, and type of task. On the display screen of FIG. 3a, other information about one or more tasks may be displayed. In this embodiment of the present disclosure, information about the Pepsi summer display promo task is displayed. Information displayed includes but is not limited to questions and answers related to the task, a map, and different routes within one or more geographical regions. It should be appreciated that information related to a particular task may be sorted by store and/or by brand according to embodiments of the present disclosure.

In step 302, a task to be added may be given a title or be named. FIG. 3b depicts an example of titling a task according to an embodiment of the present disclosure. In the upper left-hand corner, the task may be named within the input block. In this embodiment, the task name may be typed into an input box, but it should be appreciated that there may be other embodiments wherein an administrator may select a task name from a drop-down menu or may be provided with other mechanisms to provide a task name without departing from the present disclosure. This may be of benefit when there may be routine tasks that a user may wish to select on more than occasion or assign to different stores or geographical locations.

In step 303, a description of a task may be entered. This may be considered an optional step insofar as there may be some tasks wherein no description may be needed. However, there may be some embodiments wherein a task description may be employed for ease of understanding what the task is, especially in circumstances where, for example, a number of tasks have similar titles, or a user has a plurality of tasks to be managed within the system. FIG. 3b depicts an example of a screen where a task may be described after it has been titled according to an embodiment of the present disclosure.

In step 304, an administrator may tap or click the type of question that he/she wishes to be associated with the task that has been titled and/or described in steps 302 and 303. FIG. 3b provides several icons wherein an administrator may select the type of question. In some embodiments of the present disclosure, an administrator may be presented with a plurality of icons from which to select. For example, the question may be a yes/no question (represented by the Y/N icon in FIG. 3b), a barometer-type question (represented by the scale icon in FIG. 3b), a financial question (represented by the dollar sign in FIG. 3b), a unit/count question (represented by the bar graph icon in FIG. 3b) and a photo/video/audio input (represented by the camera icon in FIG. 3b). It should be appreciated that more or fewer icons may be represented on this display screen without departing from the present disclosure. It also should be appreciated that different icons may be utilized without departing from the present disclosure.

In step 305, an administrator may be prompted to type in a question in response to the question selection that may take place in step 304. FIG. 3c depicts an example of a display screen that may be employed to provide an administrator with an input box to type in a question upon selecting the scale icon according to an embodiment of the present disclosure. It should be appreciated that while FIG. 3c is depicted as requiring an administrator to type in a question, an administrator also may be prompted with a drop-down menu of questions or another selection mechanism from which to select a question to be asked without departing from the present disclosure.

In step 306, once an administrator has identified one or more questions that may be associated with a task, the administrator may be presented with an option to arrange or rearrange the order that the questions may be asked to one or more users. FIG. 3d depicts an embodiment of the present disclosure where three questions are being asked related to a task (a yes/no question, a unit/count question, and a barometer-type question). The administrator may elect to delete one or more of the questions associated with the task. The administrator also may modify the order that the questions may be asked, such as by dragging each box containing a question up or down using a mouse or his/her finger (such as if an iPhone or iPad may be used). It should be appreciated that more or fewer questions may be presented without departing from the present disclosure.

In step 307, an administrator may select one or more geographical or divisional areas to which the task may be assigned. The administrator may drill down to the level that he/she wants to assign the task. In some embodiments of the present disclosure, the task may be sent to a broad geographical area (such as all stores in Texas), or it may be narrowed to a specific city or area or the city without departing from the present disclosure. FIG. 3e depicts an example where a price check task may be focused on the South Western region of the country. In this embodiment of the present disclosure, the South Western region may be considered Region 5, and the administrator may be presented with the option to select one or more Zones within the Region to assign the task. Zones may be selected, for example, by checking boxes beside each Zone number. However, other selection mechanisms may be utilized without departing from the present disclosure. It also should be appreciated that an administrator may drill down more narrowly, for example, within a selected Zone by selecting the arrow associated with a Zone. Accordingly, if certain cities or stores were associated with a Zone, the administrator may further narrow the assignment to one or more specified cities or stores according to embodiments of the present disclosure.

In step 308, once an administrator has identified the geographical or divisional areas to which the task may be assigned, the administrator may then select brands, customers or other limiting elements for which the task may be associated. In FIG. 3f, returning to the price check task for the South Western region example, the administrator may select certain products and/or certain stores where the task may be performed. In this embodiment of the present disclosure, the administrator may be interested in having users perform a price check on a variety of soft drink and water-related products so that all of the products have been selected, such as through a check-box selection mechanism, depicted in FIG. 3f. Further, the administrator may elect to have the price check performed as to all of the checked products within one or more types of stores. In this embodiment of the present disclosure, an administrator may select all Safeway supermarkets, all CVS drugstores, and all Wal-Mart stores within the specified geographical or divisional region. It should be appreciated that names of particular stores may be provided as options to be selected according to some embodiments of the present disclosure. In other embodiments of the present disclosure, the options may be more generic, such as grocery stores or drugstores, and then the user may be presented, for example, with a drill-down option to limit the search to particular grocery stores or drugstores without departing from the present disclosure.

In step 309, the administrator may select a “finish” button or other similar mechanism to indicate that he/she has completed the entries related to a task. Once this mechanism has been selected, the system may then distribute the tasks to users that have been identified through the task creation process.

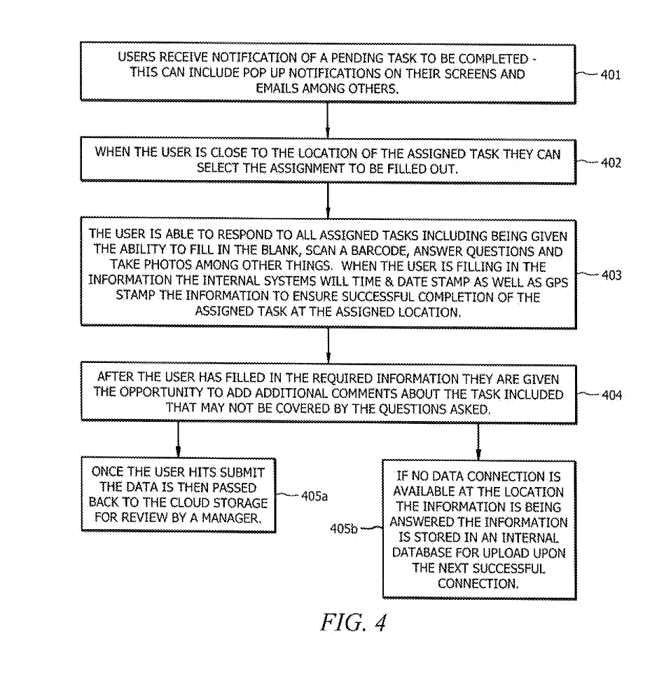

FIG. 4 depicts a flow chart for responding to a task according to an embodiment of the present disclosure. In step 401, one or more users may be provided with notification of a pending task to be completed. A notification may be sent through various mechanisms, including through electronic mail, a text message, a push notification, or other communication with the administration system over a wireless communication network, such as the Internet. In an embodiment of the present disclosure, a user may receive a pop-up notification on the display screen of his/her mobile device within the system application. However, other forms of notification may be employed without departing from the present disclosure.

In step 402, if a user assigned to one or more tasks nears the location where the assigned task(s) may be performed, he/she may select the assignment to be completed on his/her display screen. In step 403, the user may respond to all assigned tasks, including but not limited to, being given the ability to fill in the blank to answer a question, scan/read a bar code, answer other questions, take photos, and record video and/or audio. A user may input each item of information to respond to a task using his/her mobile device, such as her/her mobile phone, tablet, or laptop computer. While the user inputs information, the system may apply date and time stamps, and the system also may apply a GPS or other location-based stamp to ensure successful completion of each assigned task at the assigned location and at a specified date/time, if needed.

In step 404, after a user has entered information to respond to an assigned task, he/she may be provided with an opportunity to add additional comments about the task. This may give the user a chance to provide comments that may not have been covered by the questions that were associated with the assigned task. For example, if the assigned task was to provide information about the stock level of a particular product within the store, and the user identified something unusual about the pricing of the particular product, he/she may elect to provide comments about pricing even though that was not a question asked with respect to the task. It should be appreciated however that there may be instances where a user may elect not to enter additional comments and may proceed directly to step 405a or 405b without departing from the present disclosure.

When the user has completed all of the entries associated with an assigned task, if the user has a wireless connection, in step 405a, the data associated with the assigned task may be transmitted over a wireless communication network to one or more cloud storage databases where it may be reviewed by an administrator or manager. However, if no data connection is available to the user at the physical location where the user has entered the information related to an assigned task, the inputted information may be stored in an internal database or memory associated with the user's mobile device until the next time when the user's mobile device may transmit information over a wireless communication network. While transmission has been described as occurring over a wireless communication network, it should be appreciated that there may be embodiments wherein a user may connect to the network over a wired communication mechanism to transmit the information about an assigned task without departing from the present disclosure.

It should be appreciated that there may be embodiments of the present disclosure where a user may be given a specified amount of time to provides answers in connection with an assigned task. In some embodiments of the present disclosure, the user may be sent periodic reminders to provide information related to an assigned task to the system. In additional or other embodiments of the present disclosure, the user may be provided with a drop-dead deadline to provide responses in connection with an assigned task. If the responses are not provided within an allotted period of time, an escalation message may be sent to the user's supervisor or another administrator so that the user may either be reminded again to complete the questions or the questions may be reassigned to another user to complete.

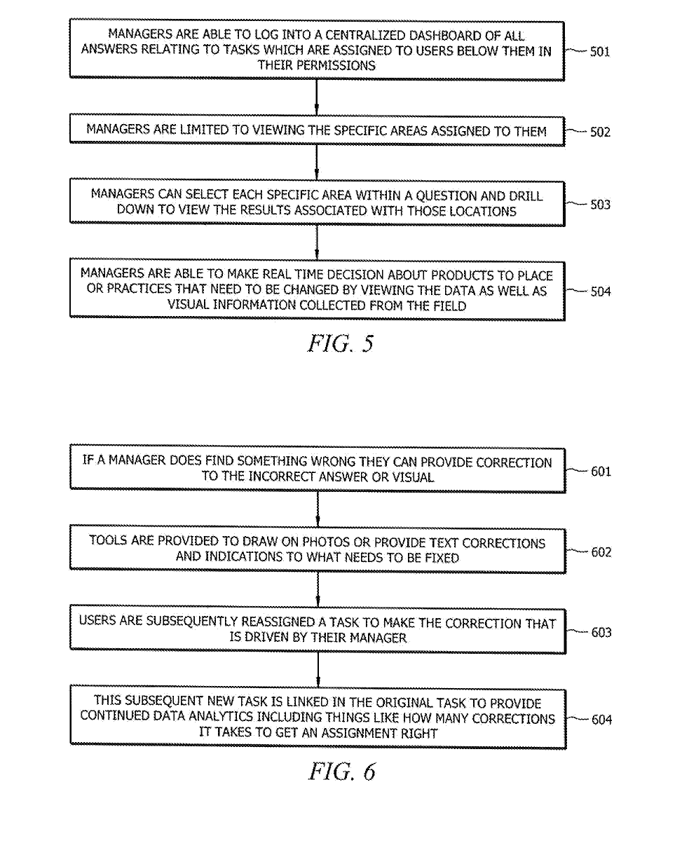

FIG. 5 is a flow chart depicting how results may be reviewed according to an embodiment of the present disclosure. It should be appreciated that when results are reviewed, an administrator may download or save the results locally for future analysis according to some embodiments of the present disclosure.

In step 501, an administrator, such as a manager, may log into a centralized dashboard of all information (or answers) that have been provided in connection with an assigned task. It should be appreciated that the administrator may have certain permissions to access certain information according to some embodiments of the present disclosure. Accordingly, if one administrator is focused on information related to pricing, that administrator may have access to the information related to product pricing, while another administrator that may be focused on cleanliness of a store where a product is being sold may not be given permission to access information related to product pricing. In order to control permissioning, each administrator may be assigned a separate user name and password to access the administration system according to some embodiments of the present disclosure. Step 502 reflects that certain administrators may be limited to viewing specific areas that they have been given permission to view. In step 503, an administrator may select each specific area within a question and then drill down to view the results associated with certain locations. For example, if an administrator is interested in the cleanliness ratings for different stores within a specific geographic location, he/she may select the cleanliness question, select the stores (store type or actual stores) and a geographical location to view the results.

In step 504, an administrator may make real-time decisions, for example, about products to be placed or practices that may need to be changed within a store or a geographical location, by viewing the answers to questions provided in response to certain tasks as well as visual information collected from the field. In an embodiment of the present disclosure, if the administrator views the unit counts for a specific product across a number of store locations and determines that the unit counts are low, he/she may provide directions to have those particular store locations re-stocked in a timely manner. Similarly, in another embodiment of the present disclosure, if an administrator reviews the results and determines that the cleanliness rating for a given store location is low and/or he/she views photos or video from the store location and determines that the store appears less clean than is desired, he/she may send directions to the store to address the situation.

FIG. 6 is a flow chart depicting how incorrect or undesirable results may be corrected according to an embodiment of the present disclosure. In step 601, if something is wrong in the entry of information related to an assigned task, an administrator may provide correction associated with an incorrect answer or visual information collected in the field. In step 602, tools may be provided within the administration system so that an administrator may draw on photos that have been transmitted through the administration system to identify corrections to be made in some embodiments of the present disclosure. In additional or other embodiments of the present disclosure, an administrator may transmit a message to a user over a wireless communication network that may provide textual corrections to be made and/or indications as to what might need to be fixed in the field. For example, if a store display has been misassembled or products are incorrectly placed, an administrator may provide textual and/or photographic instructions to the user to direct him/her how to correct the store display or the product placement. Audio and/or video instructions also may be provided in some embodiments of the present disclosure. In step 603, the same user that initially submitted information to the administration system may be directed to make corrections as directed by the administrator according to an embodiment of the present disclosure. In additional or other embodiments of the present disclosure, if the user that initially submitted the information is not available or the administrator desires to identify another user, then the administrator may reassign the task to another user to make the corrections as defined by the administrator. In step 604, the revised or reassigned task may be linked to the originally assigned task so that continued data analytics may be transmitted to the administration system. Continued data analytics may include but are not limited to information about how many corrections were required to complete the assigned task, how much time it took to complete the corrections, and how many people were involved in making the corrections.

While FIG. 6 has been described in the context of corrective tasks being assigned following review by an administrator, it should be appreciated that there may be embodiments of the present disclosure where a user may completing an assigned task may be provided with an immediate trigger when a question is answered incorrectly. If a yes/no question has been asked, and the answer should be “yes,” the user may be immediately prompted to take corrective measures if he/she answers the question “no.” For example, if the user is asked whether a product is placed on a certain shelf, and the user answers “no,” then the user or a manager within the store location may be prompted to change the placement of the product. In other embodiments of the present disclosure, there may not be an immediate trigger to take corrective action. For example, a manager at a store location may be provided with a digest on a periodic (i.e., hourly, daily, weekly) basis to identify items that may require corrective measures to be taken. In some embodiments of the present disclosure, a manager may be provided with reminders to take corrective action in response to answers given with respect to an assigned task.

While several of the embodiments have been described in the retail context, it should be appreciated that systems and methods of verifying and remediating an assigned task may be employed in other industries and for other applications without departing from the present disclosure. For example, a governmental entity, such as a city, may utilize systems and methods according to embodiments of the present disclosure for code and health inspections.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for verifying completion of a task using a user interface over a wireless communication network, the method comprising:
accessing a centralized administration system;
creating at least one task associated with a location, the at least one task including at least one question to be answered by at least one user in a remote location;
assigning the at least one task to the at least one user; and
verifying completion of the at least one task upon receipt of a response from the at least one user.

2. The method of claim 1 further comprising:
based on the response from the at least one user, transmitting a correction to the at least one task.

3. The method of claim 1, the user interface selected from the group comprising:
a personal computer, a laptop computer, a tablet, a mobile phone, and a mobile communication device.

4. The method of claim 1, the assigning step further comprising:
prompting the at least one user to complete the at least one task by a specific date and time.

5. The method of claim 1 wherein the response from the at least one user is selected from the group comprising:
providing a yes/no answer, a photo, an audio response, a video response, an answer to a multiple choice question, a textual answer, and combinations thereof.

6. The method of claim 1 wherein the response is received from more than one geographical location.

7. A method of task creation for verifying and remediating the task on a centralized administration system via a wireless communication network, the method comprising:
adding at least one task to the centralized administration system;
inputting at least one question associated with the at least one task;
transmitting a notification from at least one server to a user interface associated with at least one user to complete the at least one task;
reviewing answers to the at least one question associated with the at least one task; and
remediating any incorrect answers to the at least one question by transmitting at least one follow up question to the at least one user.

8. The method of claim 7 further comprising:
titling the at least one task; and
entering a description of the at least one task.

9. The method of claim 7 further comprising:
selecting at least one limiting element for which the at least one task is associated, the at least one limiting element selected from the group comprising:
a brand, a product, a service, and a customer.

10. The method of claim 7 further comprising:
selecting at least one geographical location to which the at least one task is assigned.

11. The method of claim 10 wherein the at least one geographical location comprises one or more of the following:
a route, a division, a zone, a city, a state, a country, and a store location.

12. The method of claim 7 further comprising:
selecting at least one geographical location to which the at least one task is assigned; and
selecting at least one limiting element for which the at least one task is associated, the at least one limiting element selected from the group comprising:
a brand, a product, a service, and a customer.

13. The method of claim 7 wherein the notification is selected from the group comprising:
an email message, a text message, a push notification, and a pop-up notification within a web application.

14. The method of claim 7 wherein the at least one question is selected from the group comprising:
a yes/no question, a multiple choice question, a barometer-type question, a financial question, a unit/count question, a photo input, an audio input, and a video input.

15. A method of a responding to a task created on a centralized administration system over a wireless communication network, the method comprising:
receiving a notification of at least one task to be completed on a user interface;
utilizing the user interface, selecting one of the at least one task and answering questions associated with the task;
transmitting to one or more cloud storage databases on the centralized administration system answers to the questions associated with the task; and
receiving a notification of corrective tasks to be completed in response to the submitting step.

16. The method of claim 15, wherein the notification is selected from the group comprising:
an email message, a text message, a push notification, and a pop-up notification within a web application.

17. The method of claim 15 wherein the user interface is selected from the group comprising:
a personal computer, a laptop computer, a tablet, a mobile phone, and a mobile communication device.

18. The method of claim 15 further comprising:
receiving one or more reminders to answer questions associated with the task when the one or more cloud storage databases have not received the answers within a specified period of time.

19. The method of claim 15 wherein the questions are selected from the group comprising:
a yes/no question, a multiple choice question, a barometer-type question, a financial question, a unit/count question, a photo input, an audio input, and a video input.

20. The method of claim 15, wherein the user interface comprises:
an internal storage database to store answers to the questions when no wireless data connection is available.
